(19) United States
(12) Patent Application Publication
(10) Pub. No.: US 2014/0353250 A1
(43) Pub. Date: Dec. 4, 2014

(54) USE OF LONG CHAIN INTERNAL OLEFIN SULFONATES

(71) Applicant: SHELL OIL COMPANY, Houston, TX (US)

(72) Inventors: Thomas Carl SEMPLE, Friendswood, TX (US); Carmen REZNIK, Friendswood, TX (US); Julian Richard BARNES, Amsterdam (NL); James Laurel BUECHELE, Sugar Land, TX (US); Sheila Teresa DUBEY, Houston, TX (US); Timothy Elton KING, Houston, TX (US)

(73) Assignee: SHELL OIL COMPANY, Houston, TX (US)

(21) Appl. No.: 14/271,885

(22) Filed: May 7, 2014

Related U.S. Application Data
(60) Provisional application No. 61/822,722, filed on May 13, 2013.

(51) Int. Cl. E21B 43/16; C09K 8/584; E21B 43/34

(52) U.S. Cl. CPC E21B 43/16; E21B 43/34; C09K 8/584
USPC 210/634; 166/268; 166/270.1; 166/305.1

(57) ABSTRACT

The present invention provides a method for treating a formation containing crude oil hydrocarbons, comprising injecting an aqueous composition comprising an internal olefin sulfonate with a nominal carbon chain length between 24 to 44 into said formation and displacing said crude oil hydrocarbons toward one or more production wells. The invention further provides a method for treating a formation containing crude oil hydrocarbons, a method for improving the wettability of a subsurface surface in an subsurface formation containing crude oil hydrocarbons, and a method for separating crude oil hydrocarbons from crude oil hydrocarbons compositions.

### CROSS-REFERENCE TO RELATED APPLICATIONS

The present non-provisional application claims the benefit of pending U.S. Provisional Patent Application Ser. No. 61/822,722, filed May 13, 2013, the entire disclosure of which is hereby incorporated by reference.

### FIELD OF THE INVENTION

The present invention provides methods for treating a formation containing crude oil hydrocarbons, a method for improving the wettability of a subsurface surface in a subsurface formation containing crude oil hydrocarbons, and a method for separating crude oil hydrocarbons from crude oil hydrocarbons compositions.

### BACKGROUND TO THE INVENTION

Internal olefin sulfonates (IOS) have been widely reported in the prior art for application as detergents and various other surfactant applications. In addition it has been reported that such IOS may also be used as a surfactant in enhanced oil recovery (EOR), specifically in traditional alkaline-surfactant (AS) and alkaline-surfactant-polymer (ASP) chemical floods in tertiary oil recovery.

Hydrocarbons may be recovered from hydrocarbon-bearing formations by penetrating the formation with one or more wells. Hydrocarbons may flow to the surface through the wells. Conditions (e.g., permeability, hydrocarbon, concentration, porosity, temperature, pressure, amongst others) of the hydrocarbon containing formation may affect the economic viability of hydrocarbon production from the hydrocarbon containing formation. A hydrocarbon-bearing formation may have active natural drive mechanisms (e.g., gas, water) that aid in mobilizing hydrocarbons to the surface of the hydrocarbon containing formation. Natural drive may be in the form of water. Water may exert pressure to mobilize hydrocarbons to one or more production wells. Gas may be present in the hydrocarbon-bearing formation (reservoir) at sufficient pressures to mobilize hydrocarbons to one or more production wells. The natural drive mechanism typically becomes become depleted over time. Supplemental recovery processes may be used to continue recovery of hydrocarbons from the hydrocarbon containing formation. Examples of supplemental processes include waterflooding, thermal processes, gas injection and chemical flooding. Chemical flooding includes polymer, alkali, surfactant and combinations thereof.

In surfactant-based enhanced oil recovery (EOR) the mobilization of residual oil saturation is achieved through surfactants which generate a sufficiently (ultra) low crude oil/water interfacial tension (IFT) to give a capillary number large enough to overcome capillary forces and allow the oil to flow (I. Chatzis and N. R. Morrows, “Correlation of Capillary Number Relationship for Sandstone”, SPE Journal, Vol. 29, pages 555-562, 1989).

Compositions and methods for enhanced hydrocarbons recovery utilizing an alpha olefin sulfate-containing surfactant component are known. U.S. Pat. Nos. 4,488,976 and 4,537,253 describe enhanced oil recovery compositions containing such a component. Compositions and methods for enhanced hydrocarbons recovery utilizing internal olefin sulfonates are also known. Such a surfactant composition is described in U.S. Pat. No. 4,597,879.

U.S. Pat. No. 4,979,564 describes the use of internal olefin sulfonates in a method for enhanced oil recovery using low tension viscous water flood. An example of a commercially available material described as being useful was ENORDET IOS 1720, a product of Shell Oil Company identified as a sulfonated C₁₇₋₂₀ internal olefin sodium salt. This material has a low degree of branching.

U.S. Pat. No. 5,068,043 describes a petroleum acid soap-containing surfactant system for waterflooding wherein a cosurfactant comprising a C₁₇₋₂₀ or a C₂₀₋₂₄ internal olefin sulfonate was used.

To improve handling and solubility when used in EOR, the IOS are occasionally combined with a viscosity reducing agent, e.g., a co-solvent. This has for example been described in WO2011/100301.

Many of the prior art publications on the use of IOS in EOR have focused on IOS with a maximum carbon chain length of 24, see for instance Van Os et al. (Van Os et al., “Olefinsulfonates”, in Anionic Surfactants: Organic Chemistry, 2nd Ed.; Stache, H. W., Ed., pages 363-459).

Internal olefin sulfonates with a carbon chain length greater than 24, henceforth known as long chain IOS, have been manufactured. Several publications detail the processes used to manufacture IOS with a maximum carbon chain length of 26, see for example EP0482687 and EP0351928. Fairly recently there have been publications reporting the use of long chain IOS for EOR, such as WO2011/100301. Both straight and branched IOS, with a carbon chain length up to 44 carbons, can be used in chemical floods US2010/0282467. A subset of this length, an IOS with a nominal carbon chain length of 24 to 28, was also reported for use in alkaline-surfactant-polymer (ASP) chemical floods in tertiary oil recovery. See Barnes, et al. (SPE 129766, “Application of Internal Olefin Sulfonates and Other Surfactants to EOR. Part 1: Structure—Performance Relationships for Selection at Different Reservoir Conditions”, Society of Petroleum Engineers, 2010) and Buijse et al. (SPE 129769, “Application of Internal Olefin Sulfonates and Other Surfactants to EOR. Part 2: The Design and Execution of an ASP Field Test”, Society of Petroleum Engineers, 2010). In Barnes et al. (SPE 113313, “Development of Surfactants for Chemical Flooding at Difficult Reservoir Conditions” Society of Petroleum Engineers, 2010) optimal salinity and Interfacial tension behavior of IOS, including those with a nominal carbon chain length of 24 to 28, are discussed in relation to their use in chemical EOR. Long chain IOS, including C₂₄₋₂₈ were also reported to demonstrate low optimal salinities (sodium chloride concentration less than 1.5 wt %) from phase behavior tests, and high thermal stability (up to 140 degrees Celsius). Basis these reported results, the long chain IOS are good candidates for reservoirs with both low salinity and high temperature

WO2011/005746 an EOR method to treat crude oil with an IOS with a nominal chain length of 24 to 28 was disclosed.

The prior art use of long chain IOS, in particular an IOS with a nominal chain length of 24 to 28, has however been limited to traditional tertiary SP and ASP chemical flood based EOR.

### SUMMARY OF THE INVENTION

It has now been surprisingly found that, in addition to the traditional tertiary SP and ASP chemical floods, long chain IOS, specifically with a nominal carbon chain length between 24 to 44, can be utilized in other related EOR applications. It has further been found that long chain IOS, specifically with a nominal carbon chain length between 24 to 44 are particularly suitable for use in crude oil hydrocarbons containing formation that contain relatively high molecular weight crude oil hydrocarbons, also referred to as heavy crudes. Examples of such crudes include, but are not limited to, crudes contained in tar sands and oil sands.

Accordingly, the present invention provides a method for treating a formation containing crude oil hydrocarbons, comprising injecting an aqueous composition comprising an internal olefin sulfonate with a nominal carbon chain length between 24 to 44 into said formation and displacing said crude oil hydrocarbons toward one or more production wells.

In another aspect the invention provides a method for treating a formation containing crude oil hydrocarbons, comprising providing an aqueous composition comprising an internal olefin sulfonate with a nominal carbon chain length between 24 to 44 is either co-injected or alternatively injected with a carrier fluid for the purpose of foam generation during tertiary oil recovery in heterogeneous or fractured reservoirs.

In a further aspect the invention provides a method for improving crude oil hydrocarbon flow, comprising injecting a composition comprising an internal olefin sulfonate with a nominal carbon chain length between 24 to 44 in the close vicinity of a wellbore to improve fluid flow and reduce back pressure.

In still a further aspect the invention provides a method for improving the wettability of a subsurface surface in a subsurface formation containing crude oil hydrocarbons, comprising injection into the formation of a composition comprising an internal olefin sulfonate with a nominal carbon chain length between 24 to 44.

Reference herein to an internal olefin sulfonate with a nominal carbon chain length between 24 to 44 is to a blend of internal olefin sulfonates wherein the blend has an average carbon number of from 24.5 to 43 and at least 40% by weight, preferably at least 50% by weight, most preferably at least 60% by weight, of the internal olefin sulfonates in the blend contain from 24 to 44 carbon atoms.

Reference herein to a internal olefin sulfonate with a nominal carbon chain length between 24 to 36 is to a blend of internal olefin sulfonates wherein the blend has an average carbon number of from 24.5 to 35 and at least 40% by weight, preferably at least 50% by weight, most preferably at least 60% by weight, of the internal olefin sulfonates in the blend contain from 24 to 36 carbon atoms.

Reference herein to a internal olefin sulfonate with a nominal carbon chain length between 24 to 28 is to a blend of internal olefin sulfonates wherein the blend has an average carbon number of from 24.5 to 27 and at least 40% by weight, preferably at least 50% by weight, most preferably at least 60% by weight, of the internal olefin sulfonates in the blend contain from 24 to 28 carbon atoms.

### DETAILED DESCRIPTION OF THE INVENTION

In addition to the traditional tertiary SP and ASP chemical floods, long chain IOS, specifically with a nominal carbon chain length between 24 to 44, can be utilized in other related EOR applications. The long chain IOS, specifically with a nominal carbon chain length between 24 to 44, preferably between 24 to 36, more preferably between 24 and 28, are particularly suitable for use in applications that deal with heavy crude oil hydrocarbons. There exist seven well-known petroleum fluids in nature. In the order of their fluidity, they are natural gas, near-critical gas-condensate (or condensate for short), light crude, intermediate crude, heavy crude oil, tar sand and oil shale. These are all naturally occurring complex mixtures made up of hydrocarbons and other organic and inorganic compounds with variety of molecular structures and sizes. The heavy crude oils are typically comprised of a mixture of hydrocarbon molecules have a median carbon number of 22 and higher. The increased alkane tail length of the long chain IOS, i.e. with a nominal carbon chain length between 24 to 44, have a better compatibility and interaction with the higher carbon number hydrocarbon molecules in the heavy crudes compared to prior art internal olefin sulfonates with a nominal carbon chain length below 24. This becomes even more pronounced as the median carbon number of the mixture of hydrocarbon molecules in the crude increases beyond 22.

The recovery of crude oil hydrocarbons from a crude oil containing reservoir formation typically passes through three stages of recovery. In the first stage, or primary oil recovery stage, the crude oil hydrocarbons flow to the surface due to naturally existing forces that force the crude oil hydrocarbons out of the formation as a well is drilled into the formation. Examples of such naturally occurring forces are the temperature and pressure in a formation. Over time, these natural forces are depleted and production from the formation declines, giving rise to the second stage of crude oil recovery, or secondary oil recovery. During the secondary oil recovery the formation is flooded by water or an aqueous medium to increase pressure in the formation and/or to displace the remaining crude oil hydrocarbons toward a production well. Part of the crude oil hydrocarbons still remaining after the second stage can be produced in a subsequent third stage, also referred to as tertiary oil recovery or enhanced oil recovery (EOR) using compounds that alter the physical and chemical properties of the crude oil hydrocarbons or alter the physical and chemical interactions between the crude oil hydrocarbons and the formation.

In a first embodiment of the invention there is provided a method for treating a formation containing crude oil hydrocarbons, comprising injecting during the secondary oil recovery, an aqueous composition comprising an internal olefin sulfonate with a nominal carbon chain length between 24 to 44, preferably with a nominal carbon chain length between 24 to 36, more preferably between 24 to 28, into said formation and displacing said crude oil hydrocarbons toward one or more production wells. In this method the internal olefin sulfonate is injected at low concentration during secondary oil recovery. Preferably, the concentration of the internal olefin sulfonate in the aqueous composition is in the range of from 0.01 to 1.5 wt %, based on the aqueous composition, more preferably 0.05 to 1.0 wt %, based on the aqueous composition. The aqueous composition may further comprise one or more components including, but not limited to: brine, alcohols and co-surfactants. These methods are also referred to as “slow drip” provision of surfactants. Such methods have been described in the prior art, see U.S. Pat. No. 5,068,043 and U.S. Pat. No. 4,979,564, for internal olefin sulfonate with a maximum carbon chain length less than 24. The advantage of the use of an aqueous composition comprising an internal olefin sulfonate with a nominal carbon chain length between 24 to 44, preferably with a nominal carbon chain length between 24 to 36, more preferably between 24 to 28, is improved compatibility and interaction with the higher carbon number hydrocarbon molecules in the crude oil compared to prior art internal olefin sulfonates with a nominal carbon chain length below 24. Preferably, the formation comprises crude oil hydrocarbons, wherein the crude oil hydrocarbons comprise a mixture of hydrocarbon molecules with a median carbon number of the mixture of hydrocarbon molecules of at least 22, preferably a median carbon number of the mixture of hydrocarbon molecules of at least 24, more preferably a median carbon number of the mixture of hydrocarbon molecules of at least 28 (including for instance for oil sands and tar sands), still more preferably a median carbon number of the mixture of hydrocarbon molecules of at least 34 (including for instance for oil sands and tar sands oil shale).

In another embodiment the invention provides a method for treating a formation containing crude oil hydrocarbons, comprising providing into the formation an aqueous composition comprising an internal olefin sulfonate with a nominal carbon chain length between 24 to 44, preferably with a nominal carbon chain length between 24 to 36, more preferably between 24 to 28, by surfactant mixture/carrier fluid co-injection or by injection with a carrier fluid for the purpose of lowering the interfacial tension between the crude oil and water and, preferably with a second surfactant component, giving foam generation during tertiary oil recovery in heterogeneous or fractured reservoirs.

As mentioned above, preferably a second surfactant component is provided in the aqueous composition comprising an internal olefin sulfonate with a nominal carbon chain length between 24 to 44, in particular a second surfactant component having good foaming capacity, preferably better than the internal olefin sulfonate with a nominal carbon chain length between 24 to 44. Although the internal olefin sulfonate with a nominal carbon chain length between 24 to 44 of the present invention may be used to generate a foam, it is preferred that the aqueous composition comprising an internal olefin sulfonate with a nominal carbon chain length between 24 to 44 comprises a further surfactant with better foaming properties. Where the aqueous composition comprising an internal olefin sulfonate with a nominal carbon chain length between 24 to 44, includes two surfactant components, one to principally lower the interfacial tension between the crude oil and the water and mobilize the oil and a second to principally foam with a gaseous carrier fluid and give improved mobility control (compared with the carrier fluid alone). The internal olefin sulfonate with a nominal carbon chain length between 24 to 44 will in such an embodiment largely play the role of the first surfactant component. The aqueous composition of surfactants are either co-injected or alternatively injected with the carrier fluid during tertiary oil recovery in heterogeneous or fractured reservoirs.

The aqueous composition may further comprise one or more components including, but not limited to: brine, alcohols and co-surfactants. The carrier fluid preferably comprises at least one of steam, nitrogen, carbon dioxide, methane, other gaseous hydrocarbons, or any combination thereof. The above described application is particularly suitable for mobility control of the hydrocarbons in the formation. The internal olefin sulfonate herein acts as a foam generator. The advantage of the use of an aqueous composition comprising an internal olefin sulfonate with a nominal carbon chain length between 24 to 44, preferably with a nominal carbon chain length between 24 to 36, more preferably between 24 to 28, is improved compatibility and interaction with the higher carbon number hydrocarbon molecules in the crude oil compared to prior art internal olefin sulfonates with a nominal carbon chain length below 24. Preferably, the formation comprises crude oil hydrocarbons, wherein the crude oil hydrocarbons comprise a mixture of hydrocarbon molecules with a median carbon number of the mixture of hydrocarbon molecules of at least 22, preferably a median carbon number of the mixture of hydrocarbon molecules of at least 24, more preferably a median carbon number of the mixture of hydrocarbon molecules of at least 28 (including for instance for oil sands and tar sands), still more preferably a median carbon number of the mixture of hydrocarbon molecules of at least 34 (including for instance for oil sands and tar sands oil shale).

In addition to the applications discussed above, long chain IOS, specifically with a nominal carbon chain length between 24 to 44 and preferably with a nominal carbon chain length between 24 to 36, more preferably between 24 to 28, may be applied for other purposes.

In a still further embodiment, the invention provides a method for improving the wettability of a subsurface surface, in particular a surface in an subsurface formation containing crude oil hydrocarbons, comprising injection into the formation a composition comprising an internal olefin sulfonate with a nominal carbon chain length between 24 to 44, preferably with a nominal carbon chain length between 24 to 36, more preferably between 24 to 28. Provision of a composition comprising an internal olefin sulfonate with a nominal carbon chain length between 24 to 44, preferably with a nominal carbon chain length between 24 to 36, more preferably between 24 to 28, may assist in altering surface from either oil-wet or mixed wet to water-wet for improved intrusion of water-soluble fluids into the formation. Fluids in a formation may wet (e.g., adhere to a surface or spread onto surface in a hydrocarbon containing formation). As used herein, “wettability” refers to the preference of a fluid to spread on or adhere to a solid surface in a formation in the presence of other fluids.

Methods to determine wettability of a hydrocarbon formation are described by Craig, Jr. in, “The Reservoir Engineering Aspects of Waterflooding”, 1971 Monograph Vol. 3, Society of Petroleum Engineers, which is herein incorporated by reference. In an embodiment, hydrocarbons may adhere to sandstone in the presence of gas or water. A surface that is substantially coated by hydrocarbons may be referred to as “oil-wet.” A surface may be oil-wet due to the presence of polar and/or or surface-active components (e.g., asphaltenes) in the hydrocarbon containing formation. Formation composition (e.g., silica, carbonate or clay) may determine the amount of adsorption of hydrocarbons on the subsurface surface. In some embodiments, a porous and/or permeable formation may allow hydrocarbons to more easily wet the surface. A substantially oil-wet surface may inhibit hydrocarbon production from the hydrocarbon containing formation.

The advantage of the use of an internal olefin sulfonate with a nominal carbon chain length between 24 to 44, preferably with a nominal carbon chain length between 24 to 36, more preferably between 24 to 28, is improved compatibility and interaction with the higher carbon number hydrocarbon molecules in the crude oil compared to prior art internal olefin sulfonates with a nominal carbon chain length below 24. Preferably, the formation comprises crude oil hydrocarbons, wherein the crude oil hydrocarbons comprise a mixture of hydrocarbon molecules with a median carbon number of the mixture of hydrocarbon molecules of at least 22, preferably a median carbon number of the mixture of hydrocarbon molecules of at least 24, more preferably a median carbon number of the mixture of hydrocarbon molecules of at least 28 (including for instance for oil sands and tar sands), still more preferably a median carbon number of the mixture of hydrocarbon molecules of at least 34 (including for instance for oil sands and tar sands oil shale).

In particular application of this embodiment, the invention provides a method for improving crude oil hydrocarbon flow, comprising injecting a composition comprising an internal olefin sulfonate with a nominal carbon chain length between 24 to 44, preferably with a nominal carbon chain length between 24 to 36, more preferably between 24 to 28, in a wellbore to improve fluid flow and reduced back pressure at the subsurface entrance to or in the area close to the subsurface entrance to the well inlet. Around the inlet an environment may exist or form, which chemical nature prevents or restricts the flow of either hydrocarbons from the formation to the well or flooding composition from the well to the formation. The introduction of the internal olefin sulfonate may preferentially alter the chemical nature of the environment existing in the close vicinity of the well inlet. Such a method may also suitably be used to clean the wellbore.

Similarly, the composition, preferably aqueous composition, comprising an internal olefin sulfonate with a nominal carbon chain length between 24 to 44, preferably with a nominal carbon chain length between 24 to 36, more preferably between 24 to 28, may be contacted with a crude oil hydrocarbons comprising composition, wherein the crude oil hydrocarbons preferably comprise a mixture of hydrocarbon molecules with a median carbon number of the mixture of hydrocarbon molecules of at least 28. Preferred examples of such crude oil hydrocarbons comprising compositions are oil sands and tar sands. These crude oil hydrocarbons comprising compositions are preferably heterogeneous mixtures comprising organic and inorganic compounds, whereby the organic compounds include the crude oil hydrocarbons and the inorganic compounds include soil components such as sand, gravel and inorganics, and the invention includes contacting the crude oil hydrocarbons comprising composition with a composition, preferably an aqueous composition, comprising an internal olefin sulfonate with a nominal carbon chain length between 24 to 44, preferably with a nominal carbon chain length between 24 to 36, more preferably between 24 to 28, and wherein during the contacting, at least part of the crude oil hydrocarbons are separated from the organic/inorganic mixture. The invention further provides for a method for separating crude oil hydrocarbons from crude oil hydrocarbons composition comprising a mixture of hydrocarbon molecules with a median carbon number of the mixture of hydrocarbon molecules of at least 28, wherein the crude oil hydrocarbons comprising composition is contacted with a composition, preferably an aqueous composition, comprising an internal olefin sulfonate with a nominal carbon chain length between 24 to 44, preferably with a nominal carbon chain length between 24 to 36, more preferably between 24 to 28, and wherein during the contacting at least part of the crude oil hydrocarbons are separated from the remainder of the crude oil hydrocarbons comprising composition. Due to the increased length of the internal olefin sulfonates used in the present invention, the interaction between the heavy crude oil hydrocarbons and the internal olefin sulfonate is improved compared to existing prior art methods using significantly shorter internal olefin sulfonates. As such the composition comprising an internal olefin sulfonate with a nominal carbon chain length between 24 to 44, preferably with a nominal carbon chain length between 24 to 36, more preferably between 24 to 28, may also suitably be used in the remediation or cleaning of contaminated soil and similar contaminated substances.

The advantage of the use of a composition comprising an internal olefin sulfonate with a nominal carbon chain length between 24 to 44, preferably with a nominal carbon chain length between 24 to 36, more preferably between 24 to 28, is improved compatibility and interaction with the higher carbon number hydrocarbon molecules in the crude oil compared to prior art internal olefin sulfonates with a nominal carbon chain length below 24. Preferably, the formation comprises crude oil hydrocarbons, wherein the crude oil hydrocarbons comprise a mixture of hydrocarbon molecules with a median carbon number of the mixture of hydrocarbon molecules of at least 28 (including for instance for oil sands and tar sands), more preferably a median carbon number of the mixture of hydrocarbon molecules of at least 30, still more preferably a median carbon number of the mixture of hydrocarbon molecules of at least 32.

It has been found that in addition to the above mentioned applications, an internal olefin sulfonate with a nominal carbon chain length between 24 to 44, preferably with a nominal carbon chain length between 24 to 36, more preferably between 24 to 28, and compositions comprising such an internal olefin sulfonate with a nominal carbon chain length between 24 to 44, preferably with a nominal carbon chain length between 24 to 36, more preferably between 24 to 28, may suitable be used as surfactants in hydraulic fracturing processes, i.e., commonly referred to as fracking.

An alternative use of internal olefin sulfonate with a nominal carbon chain length between 24 to 44, preferably with a nominal carbon chain length between 24 to 36, more preferably between 24 to 28, and compositions comprising such an internal olefin sulfonate with a nominal carbon chain length between 24 to 44, preferably with a nominal carbon chain length between 24 to 36, more preferably between 24 to 28, is in the field of Industrial and Institutional cleaners or heavy duty liquids, e.g., laundry, janitorial, vehicle care, or light duty liquid uses, e.g., detergents, hand cleaners.

1. A method for treating a formation containing crude oil hydrocarbons, comprising injecting an aqueous composition comprising an internal olefin sulfonate with a nominal carbon chain length between 24 to 44 into said formation and displacing said crude oil hydrocarbons toward one or more production wells.

2. A method according to claim 1, wherein the internal olefin sulfonate has a nominal carbon chain length between 24 to 28.

3. A method according to claim 1, wherein the concentration of the internal olefin sulfonate in the aqueous composition is in the range of from 0.01 to 1.5 wt %, based on the aqueous composition.

4. A method according to claim 1, wherein the crude oil hydrocarbons comprise a mixture of hydrocarbon molecules with a median carbon number of the mixture of hydrocarbon molecules of at least 22.

5. A method for treating a formation containing crude oil hydrocarbons, comprising providing into the formation an aqueous composition comprising an internal olefin sulfonate with a nominal carbon chain length between 24 to 44 by surfactant mixture/carrier fluid co-injection or by injection with a carrier fluid for the purpose of foam generation during tertiary oil recovery in heterogeneous or fractured reservoirs.

6. A method according to claim 5, wherein the internal olefin sulfonate has a nominal carbon chain length between 24 to 28.

7. A method according to claim 5, wherein the carrier fluid comprises at least one of steam, nitrogen, carbon dioxide, methane.

8. A method according to claim 5, wherein the crude oil hydrocarbons comprise a mixture of hydrocarbon molecules with a median carbon number of the mixture of hydrocarbon molecules of at least 22.

9. A method for improving the wettability of a subsurface surface in an subsurface formation containing crude oil hydrocarbons, comprising injection into the formation of a composition comprising an internal olefin sulfonate with a nominal carbon chain length between 24 to 44.

10. A method according to claim 9, wherein the internal olefin sulfonate has a nominal carbon chain length between 24 to 28.

11. A method according to claim 9, wherein the crude oil hydrocarbons comprise a mixture of hydrocarbon molecules with a median carbon number of the mixture of hydrocarbon molecules of at least 22.

12. A method for separating crude oil hydrocarbons from crude oil hydrocarbons compositions comprising a mixture of hydrocarbon molecules with a median carbon number of the mixture of hydrocarbon molecules of at least 28, wherein the crude oil hydrocarbons comprising composition is contacted with a composition comprising an internal olefin sulfonate with a nominal carbon chain length between 24 to 44, preferably with a nominal carbon chain length between 24 to 28, more preferably 24 to 36, and wherein during the contacting at least part of the crude oil hydrocarbons are separated from the remainder of the crude oil hydrocarbons comprising composition.
